(19) United States
(12) Patent Application Publication
(10) Pub. No.: US 2014/0109421 A1
(43) Pub. Date: Apr. 24, 2014

(54) METHOD AND DEVICE OF INSPECTING WORKPIECE FOR PROCESSING MACHINE

(71) Applicant: MAX SEE INDUSTRY CO., LTD., Taichung City (TW)

(72) Inventor: Ton-Shih LAI, Taichung City (TW)

(73) Assignee: MAX SEE INDUSTRY CO., LTD., Taichung City (TW)

(21) Appl. No.: 13/727,079

(22) Filed: Dec. 26, 2012

(30) Foreign Application Priority Data
Oct. 18, 2012 (TW) 101138464

(51) Int. Cl. G01B 5/008

(52) U.S. Cl. CPC G01B 5/008
USPC 33/503

(57) ABSTRACT

A method of inspecting a workpiece for a processing machine includes the steps of placing a workpiece on a worktable, moving a spindle located above the worktable to allow a laser sensor mounted with the spindle to be close to the workpiece, measuring a distance between the laser sensor and the workpiece by a laser beam emitted from the laser sensor on the work piece, and gathering data of the workpiece, such as size, shape or location, by moving the spindle to enable the laser beam to pass through the periphery of the workpiece.

### BACKGROUND OF THE INVENTION

1. Field of the Invention

The present invention relates generally to a processing machine, and more specifically to a method of inspecting a workpiece for a process machine and a device for performing the aforesaid method.

2. Description of the Related Art

Before a workpiece is machined by a processing machine, an operator needs to confirm the processing data of the workpiece, such as the location and orientation of the workpiece on the worktable of the processing machine, to make sure that the workpiece is positioned in good order for processing. After the workpiece is processed, the operator needs to inspecting the dimension of the workpiece, such as length, angle or arc radius, to check whether dimension of the processed workpiece meets high-precision processing requirements.

Conventionally, the workpiece inspection is operated manually or performed by a contact-type inspecting method, such that it will take a lot of time for the operator to complete the inspection of the workpiece, and further, inspection errors may occur due to space restrictions or other limiting factors. As a result, the conventional method of inspecting the workpiece has low efficiency and poor machining precision.

### SUMMARY OF THE INVENTION

It is one objective of the present invention to provide a method of inspecting a workpiece, which uses a non-contact technology to increase efficiency and raise machining precision.

To achieve this objective of the present invention, the method comprises the steps of positioning a workpiece on a worktable, moving a spindle located above the worktable to enable a laser sensor mounted with the spindle to approach the workpiece, turning on the laser sensor to generate a laser beam towards the workpiece and receive a return laser beam from the workpiece for inspecting a distance between the laser sensor and the workpiece, and moving the spindle to enable the laser beam emitted from the laser sensor to pass through a periphery of the workpiece for inspecting the workpiece.

In the method of the present invention, before the workpiece is machined, the laser beam emitted from the laser sensor passes through different sides of the workpiece in turn to define a positioning point at each of the different sides of the workpiece for determining the location of the workpiece by means of using the coordinates of the positioning points.

In the method of the present invention, after the workpiece is machined, the laser beam emitted from the laser sensor passes through the periphery of the workpiece repeatedly to define a plurality of positioning points at the periphery of the workpiece for obtaining the dimensional accuracy of the workpiece by means of using the coordinates of the points.

According to the present invention, a workpiece inspection device is provided to perform the aforesaid inspecting method, comprising a worktable for positioning the workpiece thereon, a spindle located above the worktable and moveable relative to the worktable, a laser sensor mounted with the spindle for generating a laser beam towards the workpiece and receiving the return laser beam from the workpiece for inspecting a distance between the laser sensor and the workpiece. When the workpiece inspecting device is in use, the spindle can be moved relative to the workpiece by an operator to enable the laser beam emitted from the laser sensor to pass through the periphery of the workpiece, such that the inspection data of the workpiece can be obtained quickly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a processing machine equipped with a workpiece inspection device according to an embodiment of the prevent invention;

FIG. 2 is a schematic drawing of the workpiece inspection device according to the embodiment of the prevent invention, showing the laser sensor is moved to a location above the workpiece;

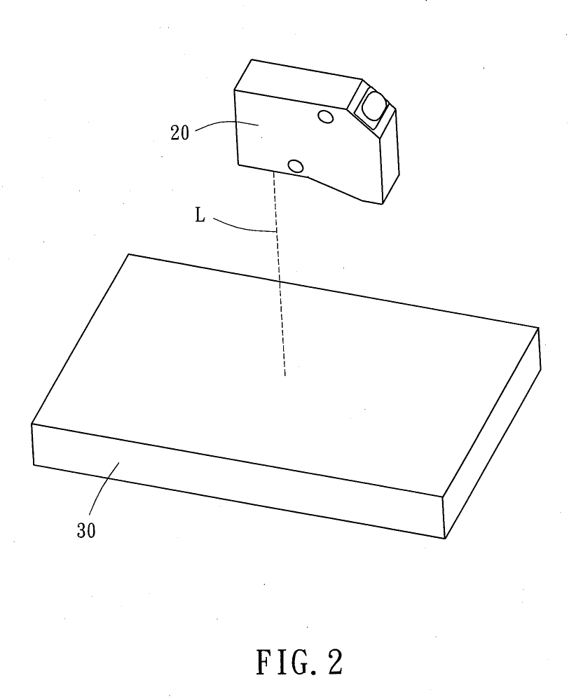

FIG. 3 is similar to FIG. 2, but showing the laser beam passes through four different sides of the workpiece along a path; and

FIG. 4 is similar to FIG. 3, but showing the laser beam passes through the periphery of the workpiece along a zigzag path.

### DETAILED DESCRIPTION OF THE INVENTION

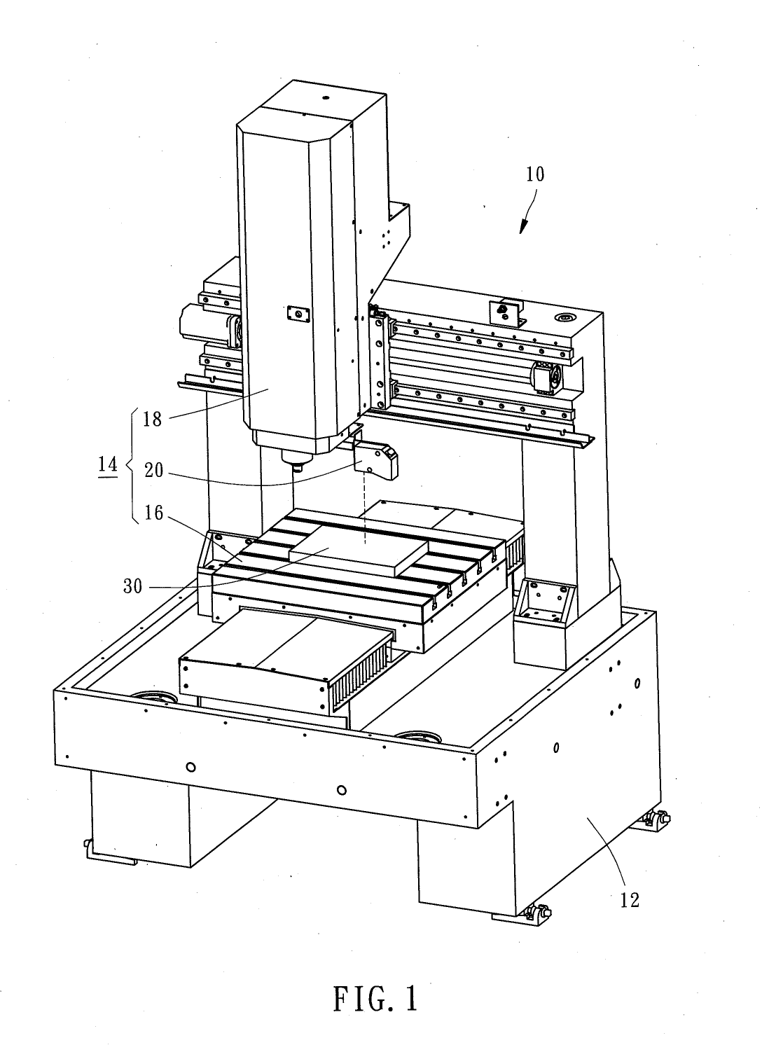

As shown in FIG. 1, a workpiece inspection device 14 in accordance with an embodiment of the present invention is installed in a processing machine 10, comprising a worktable 16, a spindle 18, and a laser sensor 20.

The worktable 16 is mounted on a support base 12 of the processing machine 10 for placing and positioning a workpiece 30 thereon.

The spindle 18 is movably mounted with the support base 12 and located above the worktable 16 so as to be moveable relative to the worktable 16.

The laser sensor 20 is fixedly mounted to one side of the spindle such that the laser sensor 20 is moveable along with the spindle 18. The laser sensor 20 is capable of generating a laser beam L towards the workpiece 30 and receiving the return laser beam from the workpiece 30.

The structure of the workpiece inspection device 14 is described as above, and two different methods of inspecting the workpiece 30 of the present invention are outlined hereinafter.

The first method is used to confirm the thickness and location of the workpiece 30 before the workpiece 30 is machined.

The first step is to place and position the workpiece 30 on the worktable 16, wherein the workpiece 30 has a first side 31, a third side 33 opposite to the first side 31, a second side 32 connected between the first and third sides 31 and 33, and a forth side 34 opposite to the second side 32 and connected between the first and third sides 31 and 33.

The second step is to move the spindle 18 to enable the laser sensor 20 to move to a location right above on the worktable 30.

The third step is to turn on the laser sensor 20 for enabling the laser sensor 20 to generate the laser beam L towards the workpiece 30 and receive the return laser beam L from the workpiece 30 for measuring the thickness of the workpiece 30 by means of inspecting a distance between the laser sensor 20 and the workpiece 30.

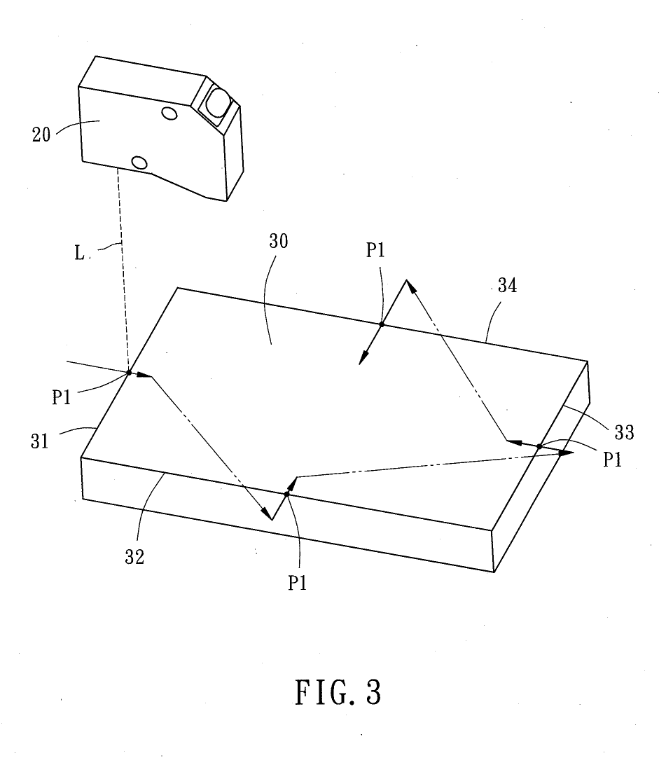

The forth step is to move the spindle 18 to enable the laser beam L emitted from the laser sensor 20 to move from the first side 31 of the workpiece 30 to the forth side 34 of the workpiece 30 through the second and third sides 32 and 33 of the workpiece 30 along a path having a plurality of straight routes. In other words, the laser beam L passes through the four different sides 31-34 of the workpiece 30 in turn, such that a first positioning point P1 is defined by the laser beam L at each of the four sides 31-34 of the workpiece 30, as shown in FIG. 3. As a result, the location of the workpiece 30 can be determined by using the coordinates of the first positioning points P1.

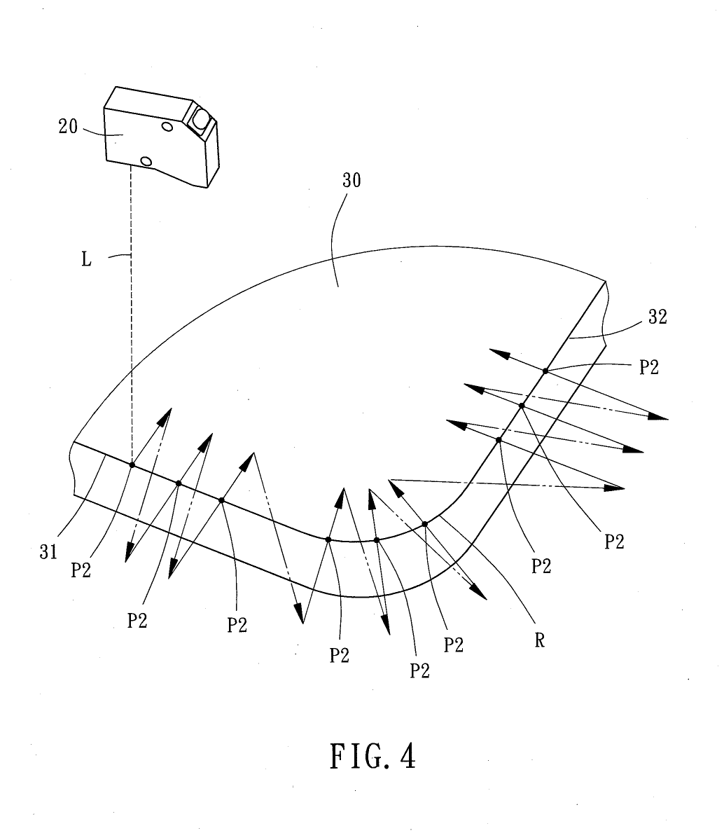

Besides, the second method is used to check the dimensional accuracy of the workpiece 30 after the workpiece 30 is machined. For example, the forth step is to move the spindle 18 to enable the laser beam L to pass from the first side 31 to the second side 32 through a rounded chamfer R provided at a joint between the first and second sides 31 and 32 along a zigzag path, such that a plurality of second positioning points P2 are defined by the laser beam L at the periphery of the workpiece 30, as shown in FIG. 4. Thus, the dimensional accuracy of the workpiece 30, such as length, width, parallelism, straightness or radian, can be checked by measuring a straight line or an arc line connected by the second points P2.

As indicated above, the workpiece inspection device 14 of the present invention utilizes the laser beam L to pass through the surface of the workpiece 30; that is to say, a non-contact inspecting method is employed to obtain the inspection data of the workpiece 30. Compared to the manual operation or other contact-type operation of the prior art, the inspecting method of the present invention has higher efficiency and machining precision to achieve the purpose of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of inspecting a workpiece for a processing machine, comprising the steps of:
a) positioning a workpiece on a worktable;
b) moving a spindle located above the worktable to enable a laser sensor mounted with the spindle to approach the workpiece;
c) turning on the laser sensor to generate a laser beam towards the workpiece and receive a return laser beam from the workpiece for inspecting a distance between the laser sensor and the workpiece; and
d) moving the spindle to enable the laser beam emitted from the laser sensor to pass through a periphery of the workpiece for inspecting the workpiece.

2. The method as claimed in claim 1, wherein in step d) the laser beam emitted from the laser sensor passes through different sides of the workpiece along a path having straight routes sequently such that a positioning point is defined by the laser beam at each of the different sides of the workpiece for determining the location of the workpiece on the worktable by using coordinates of the positioning points.

3. The method as claimed in claim 2, wherein the workpiece has a first side, a third side opposite to the first side, a second side connected between the first and third sides, and a forth side opposite to the second side and connected between the first and third sides; the laser beam moves along the path from the first side to the forth side through the second side and the third side.

4. The method as claimed in claim 1, wherein in step d) the laser beam emitted from the laser sensor passes through the periphery of the workpiece along a zigzag path such that a plurality of points are defined by the laser beam at the periphery of the workpiece for checking a dimensional accuracy of the workpiece by using coordinates of the points.

5. The method as claimed in claim 4, wherein the workpiece has a first side, a second side connected with the first side, and a chamfer at a junction between the first and second sides, and the laser beam moves along the zigzag path from the first side to the second side through the chamfer.

6. A workpiece inspection device for performing the method of claim 1, the workpiece inspection device comprising:
a worktable for positioning a workpiece thereon;
a spindle located above the worktable and moveable relative to the worktable;
a laser sensor mounted with the spindle for generating a laser beam towards the workpiece and receiving a return laser beam from the workpiece.

7. The workpiece inspection device as claimed in claim 6, wherein the spindle is moveable relative to the worktable in a way that the laser beam emitted from the laser sensor passes through different sides of the workpiece along a path having straight routes.

8. The workpiece inspection device as claimed in claim 6, wherein the spindle is moveable relative to the worktable in a way that the laser beam emitted from the laser sensor passes through a periphery of the workpiece along a zigzag path.
